(19) United States
(12) Patent Application Publication
(10) Pub. No.: US 2009/0217097 A1
(43) Pub. Date: Aug. 27, 2009

(54) PORTAL FACILITATING TELECOMMUNICATION INSTALLATION AND REPAIR SERVICES

(75) Inventors: Erian Laperi, Wentzville, MO (US); Michael L. Cromer, O'Fallon, MO (US); Jeremy A. Dilks, East Alton, IL (US); Joel Palmer, Florissant, MO (US); Bennett C. Seyer, Ballwin, MO (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/036,961

(22) Filed: Feb. 25, 2008

(51) Int. Cl. G06F 15/16; G06F 11/28

(52) U.S. Cl. 714/37; 709/203; 714/E11.178

(57) ABSTRACT

A web server includes software to support a remotely accessible web portal for installation and repair services in conjunction with a telecommunication service provided to a customer by a provider. The software includes instructions to provide a first I&R user interface, including a plurality of selectable I&R objects in response to a first input from a remote field device, receive a second input from the remote field device indicating a user's selection of one of the I&R objects, generate a request to invoke an I&R application in response to receiving the input, transmit the request to invoke the I&R application to an I&R system, receive I&R data generated by the I&R application from the I&R system, and convey information indicative of the I&R data to the remote field device.

### BACKGROUND

1. Field of the Disclosure

The present disclosure relates to telecommunications networks and, more particularly, installation and repair services for telecommunications networks.

2. Description of the Related Art

In the field of telecommunications, installation and repair encompasses a wide variety of services including the testing and benchmarking of installed or otherwise existing connections, configuring connections for a selected speed, resetting user passwords, customer equipment configuration, and other services.

### BRIEF DESCRIPTION OF THE DRAWINGS

FIG. 1 is a block diagram of selected elements of an embodiment of a communications network;

FIG. 2 is a block diagram of selected elements of an embodiment of a remote field device suitable for use in the communications network of FIG. 1;

FIG. 3 is a block diagram of selected elements of an embodiment of a web server suitable for use in the network of FIG. 1;

FIG. 4 is a block diagram of selected elements of an embodiment of an application included in the web server of FIG. 1;

FIG. 5 illustrates selected elements of an embodiment of a method for facilitating installation and repair services;

FIG. 6 illustrates selected elements of an embodiment of an application and test tools resource of a communications network; and

FIG. 7 illustrates an embodiment of a main menu page presented to a web browser of a remote field device by an embodiment of an installation and repair web portal server;

FIG. 8 illustrates another embodiment of a main menu page presented to a web browser of a remote field device by an embodiment of an installation and repair web portal server;

FIG. 9 illustrates an embodiment of a benchmark results page presented to a web browser of a remote field device by an embodiment of an installation and repair web portal server;

FIG. 10 illustrates an embodiment of a DSL speed upgrade page presented to a web browser of a remote field device by an embodiment of an installation and repair web portal server;

FIG. 11 illustrates an embodiment of a user profile management page presented to a web browser of a remote field device by an embodiment of an installation and repair web portal server;

FIG. 12 illustrates an embodiment of a DSL password reset page presented to a web browser of a remote field device by an embodiment of an installation and repair web portal server;

FIG. 13 illustrates an embodiment of a workforce administration note posting page presented to a web browser of a remote field device by an embodiment of an installation and repair web portal server;

FIG. 14 illustrates an embodiment of an end user data lookup page presented to a web browser of a remote field device by an embodiment of an installation and repair web portal server;

FIG. 15 illustrates an embodiment of a first metallic test page presented to a web browser of a remote field device by an embodiment of an installation and repair web portal server;

FIG. 16 illustrates an embodiment of a second metallic test page presented to a web browser of a remote field device by an embodiment of an installation and repair web portal server;

FIG. 17 illustrates an embodiment of a central-office-to-remote-terminal page presented to a web browser of a remote field device by an embodiment of an installation and repair web portal server; and

FIG. 18 illustrates an embodiment of a results delivery page presented to a web browser of a remote field device by an embodiment of an installation and repair web portal server.

### DESCRIPTION OF THE EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and an un-hyphenated form of the reference numeral refers to the element generically or collectively. Thus, for example, widget 12-1 refers to an instance of a widget class, which may be referred to collectively as widgets 12 and any one of which may be referred to generically as a widget 12.

Many I&R services are deployed on legacy computing systems including legacy mainframe systems and legacy server systems. Field service technicians, on the other hand, are most frequently located at customer premises and only have direct access to a laptop or similar computing device. The disclosed subject matter encompasses a web server that includes software to support a remotely accessible web portal for installation and repair services in conjunction with a telecommunication service provided to a customer by a provider. The software includes instructions to provide a first I&R user interface, including a plurality of selectable I&R objects in response to a first input from a remote field device, receive a second input from the remote field device indicating a user's selection of one of the I&R objects, generate a request to invoke an I&R test or application in response to receiving the input, transmit the request to invoke the I&R test or application to an I&R system, receive I&R data generated by the I&R test or application from the I&R system, and convey information indicative of the I&R data to the remote field device. The I&R data might, in some cases, include an indication of a result or completion of the I&R test or application.

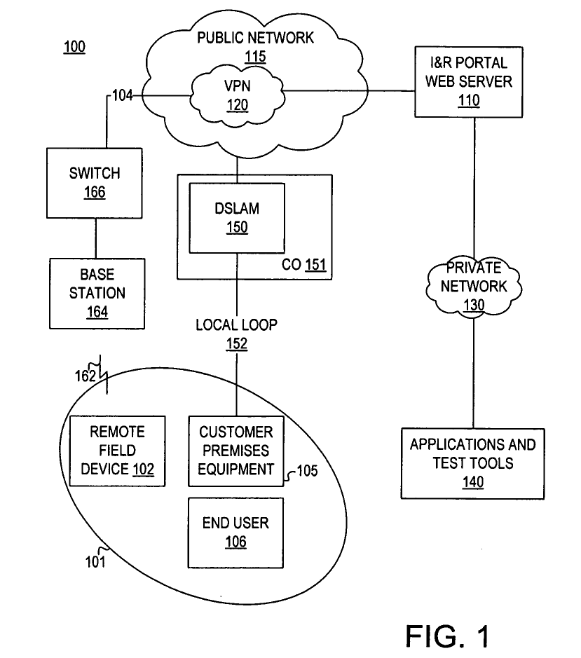

Referring now to the drawings, FIG. 1 is a block diagram illustrating selected elements of an embodiment of a communication network 100. The depicted embodiment of communication network 100 emphasizes resources that facilitate or otherwise support I&R services provided in conjunction with communication network 100. In the depicted embodiment, communication network 100 includes an I&R portal web server 110, a set of resources referred to herein as application and test (A&T) tools 140, and a remote field device (RFD) 102.

RFD 102 is operable to establish a communication connection with I&R portal web server 110. In the embodiment depicted in FIG. 1, the connection between RFD 102 and I&R portal web server 110 includes a wireless connection 162 between RFD 102 and a cellular base station 164, a wireline or wireless connection between base station 164 and a telecommunications switch 166, and a wireline or wireless connection between switch 166 and I&R portal we server 110.

At least some portion of the connection between RFD 102 and I&R portal web server 110 may be implemented using a layered or tunneled virtual private network (VPN) 120. VPN 120 as shown overlays public network 115, which may represent or include the Internet. VPN 120 represents a network that provides a desired functionality for an I&R user group. VPN 120 ensures a secure connection between RFD 102 and I&R portal web server 110. In the depicted embodiment, RFD 102 includes a wireless interface operable to establish wireless connection 162 with base station 164 using a cellular network technology.

I&R portal web server 110 as shown in FIG. 1 is connected to a set of resources collectively identified as A&T tools 140. In the depicted embodiment, I&R portal web server 110 is connected to A&T tools 140 through private network 130. Private network 130 may represent a portion of an enterprise's intranet that is implemented as an Internet protocol (IP) compliant network. Private network 130 is insulated or otherwise isolated from public network 115 by firewalls and/or other network security features (not depicted).

In the depicted embodiment, a local loop 152 connects customer premises equipment (CPE) 105 to a DSL access multiplexer (DSLAM) 150. In the depicted embodiment, DSLAM 150 is physically located in a central office (CO) 151 of a service provider. In other embodiments, DSLAM 150 may be located remotely from CO 151 to provide DSL access to customers that might not be located sufficiently close to a CO 151.

CPE 105 may include hardware used by a customer or other user to establish a broadband network connection. In some implementations, CPE 105 includes a digital customer line (DSL) modem, often connected to a combination router and gateway device. The router/gateway device may implement wireless technology to establish a wireless local area network in the customer applicable residence and/or business. CPE 105, as suggested by its name, generally resides in close proximity to a customer's physical location such as the home of a consumer customer or the business of a business customer.

In some embodiments, I&R portal web server 110 provides an interface that enables RFD 102 to access and invoke A&T tools 140 directly, i.e., without the assistance of an intervening human or other type of agent. Historically, filed I&R personnel needed to call CO 151 or a customer support service (not depicted) to obtain information and/or execute certain tests. For example, field service technicians have historically required the assistance of personnel located at a provider's central office or other location to initiate line test and/or manage the configuration of a customer's account. Using RFD 102 and I&R web portal server 110, communication network 100 as depicted in FIG. 1 enables technicians to access, with their RFDs 102, the necessary testing hardware and/or support applications directly, i.e., without intervening assistance.

A&T tools 140 may include resources for managing the customer's account, testing the customer's network connection, and/or configuring the customer's network connection. Using portal web server 110 and RFD 102, I&R field personnel are enabled to initiate and perform I&R services independently.

In some embodiments, A&T tools 140 represent legacy resources for testing a customer's broadband connection, managing the customer's account and/or user profile, and other resources and applications that may be required or desired to support the services provided to the customer. Additional detail of an embodiment of A&T tools 140 is provided below.

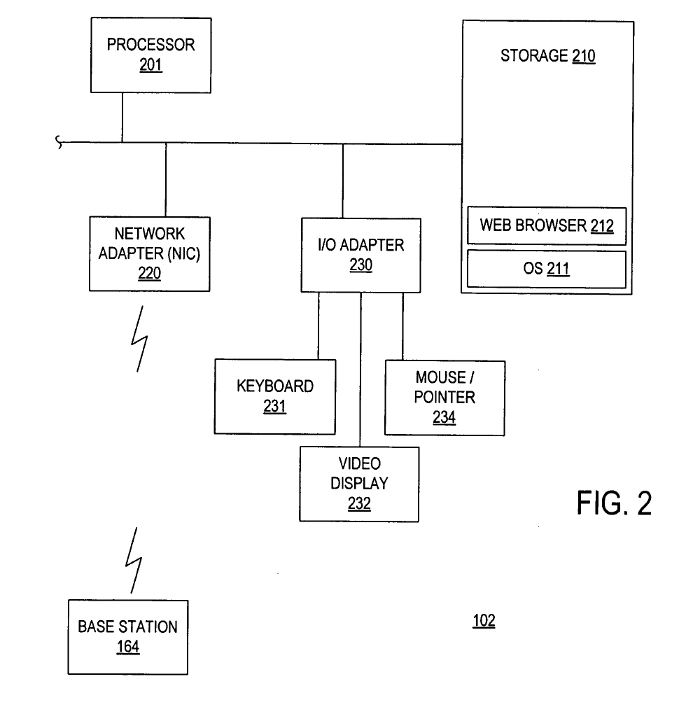

In some embodiments, RFD 102 is implemented as a notebook computer or other hand held or mobile computing device. Selected elements of an embodiment of RFD 102 are depicted in FIG. 2. In the embodiment depicted in FIG. 2, RFD 102 includes a processor 201 having access to computer readable storage represented in FIG. 2 by storage 210, a network adapter 220, and an I/O adapter 230. Processor 201 may be implemented with a general purpose microprocessor, an embedded processor, or another form of processing hardware, firmware, and software. Storage 210 encompasses persistent as well as volatile storage media including, as examples, hard disk storage, flash memory storage, removable media storage including compact disc (CDs) and digital versatile disks (DVDs), random access memory (RAM), other suitable storage devices, or a combination thereof. Although storage 210 is depicted in FIG. 2 as being an integrated component of web server 110, storage 210 could, in a different embodiment be implemented as distributed storage located on one or more external devices or systems.

Storage 210 may store computer executable instructions and/or computer accessible data structures. In the depicted embodiment, instructions embedded or otherwise included in storage 210 include instructions representing an operating system 211 and instructions representing a web browser 212. Operating system 211 may be implemented with any of various Unix®-based or Windows®-based operating systems from Microsoft. Web browser instructions 212 may be implemented with any of various conventional web browser applications such as an Apache® web browser.

I/O adapter 230, as depicted, provides an interface between various use I/O devices including a keyboard 231, a mouse or pointing device 234, and a video display 232. Network adapter (NIC) 220 facilitates communication between RFD 102 and portal web server 110 via base station 164. Network adapter 220 may be implemented as a wireless network adapter. In some embodiments, for example, wireless network adapter 220 is operable to support a cellular connection with cellular base station 164.

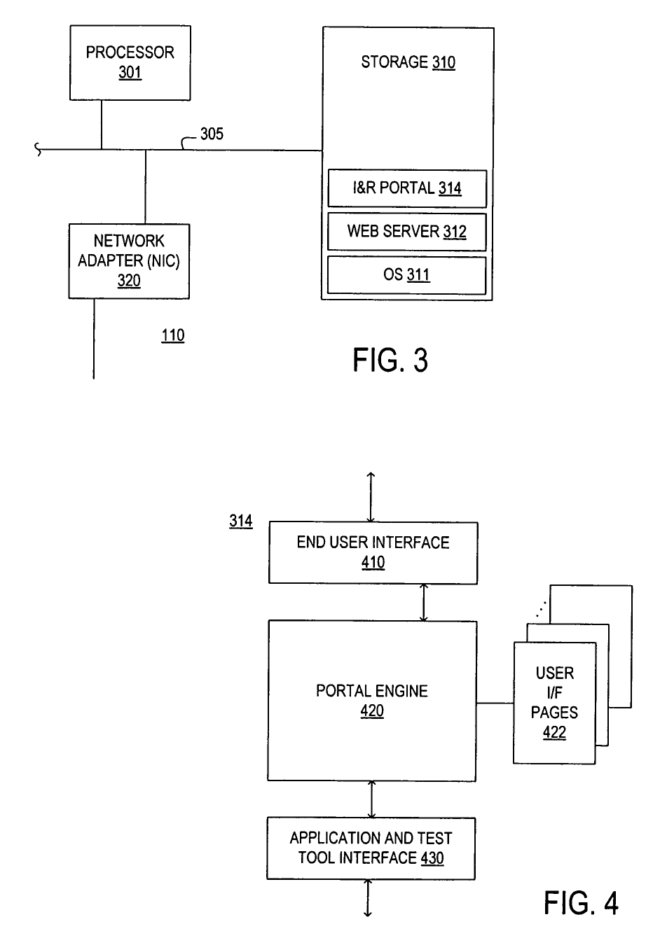

Referring now to FIG. 3, selected elements of an embodiment of I&R portal web server 110 are illustrated. The illustrated embodiment of I&R portal web server 110 is implemented as a physical or virtual server device that includes a processor 301 and a network adapter (NIC) 320 connected to a shared bus 305 that provides access to storage 310. Processor 301 may be implemented with any suitable general purpose or embedded processor. NIC 320 provides an interface between I&R portal web server 110 and an Internet protocol (IP) based or other type of network. Storage 310 encompasses various types of storage including, as examples, persistent storage media such as magnetic hard disk storage, optical storage devices such as compact disks (CDs) and digital versatile disks (DVDs), flash memory devices, electrically erasable and other types of read only memories (ROMs) as well as volatile storage media including dynamic and static random access memory (RAM) that may be used as system memory as well as any cache memory that processor 301 may employ. Storage 310 may also include storage resources and network devices (not shown).

Storage 310 may include instructions that are executable by processor 301 and data that is accessible to processor 301. The instructions represented in the depicted embodiment of storage 310 include instructions for an operating system 311, a web server 312, and a web server application or extension identified as I&R portal 314. Operating system 311 may be any suitable or conventional operating system including any suitable Unix® or Unix-like operating system and any Windows®-based operating system. Web server 312 represents a general web server application such as an Apache web server. The I&R portal 314 represents a set of web pages and/or a script called by web server 312 that implement the I&R portal application as described herein.

Referring to FIG. 4, selected elements of the functionality included within an embodiment of I&R portal 314 are illustrated. The illustrated embodiment of I&R portal 314 includes an end user interface 410, a portal engine 420, and an A&T tools interface 430. End user interface 410 receives, buffers, and performs protocol processing for requests, responses, and other messages exchanged between I&R portal web server 110 and end users including RFD 102. A&T tools interface 430 receives, buffers, and performs protocol processing for messages exchanged between I&R portal web server 110 and A&T tools 140.

Portal engine 420 processes requests from an RFD 102 or other end user and may serve a set of one or more user interface web pages 422 to the requester. Portal engine 420 may also generate and transmit requests for A&T tools 140 and receive and process responses and other messages from A&T tools 140. The I&R portal 314 may support multiple RFDs 102, in which case, portal engine 420 and/or web server 312 may include functionality to associate messages received from A&T tools 140 with the applicable requests from RFDs 102.

The I&R portal 314 may, as an example, provide a graphical user interface (GUI) to RFD 102 containing one or more selectable objects when RFD 102 accesses I&R portal web server 110. When RFD 102 sends a GUI action such as selecting a button or other menu object, portal engine 420 may receive the action and respond by generating a request for a test or application and transmitting the request to A&T tools 140. Portal engine 420 may further detect a message from A&T tools 140 that includes information pertaining to the request. In the case of a request to perform a test, for example, the response from A&T tools 140 may include the test results. Portal engine 420 may then interpret the results and/or generate a message containing information indicative of the results or a conclusion derived from the results and transmit the message to RFD 102.

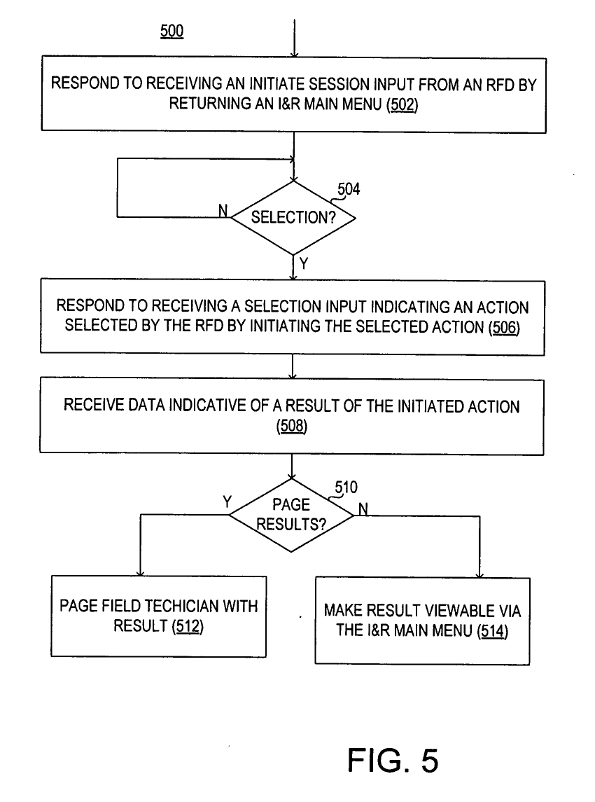

Referring now to FIG. 5, selected elements of an embodiment of an I&R portal method 500 are depicted. Method 500 may represent actions performed by I&R portal 314 and/or I&R portal web server 110. Method 500 may be implemented as a computer program product comprised of executable instructions stored in one or more computer readable media such as storage 310.

In the depicted embodiment, method 500 includes a block for responding (block 502) to receipt of an initial message, referred to as an initiate session request, from RFD 102 by returning an I&R main menu GUI. Method 500 then loops or monitors until a user selection is detected (block 504) in the form of a user action taken with respect to main menu GUI.

Method 500 as depicted includes responding (block 506) to receiving a selection input indicating an action selected by RFD 102 by initiating the selected action. Initiating the selected action, in some cases, may include generating a request message indicating the action to be taken and transmitting the request message to A&T tools 140. For example, in the context of an embodiment of A&T tools 140 specific to digital customer line (DSL) applications and tests, a user of RFD 102 may select a benchmark test from the main menu GUI. Method 500 as depicted may respond to the RFD's selection of a benchmark test by requesting A&T tools 140 to initiate a DSL benchmark test. When the appropriate resource within A&T tools 140 executes and completes the benchmark test, A&T tools 140 may then send a message to I&R portal web server 110 containing the results of the benchmark test. Method 500 as depicted includes I&R portal web server 110 and/or I&R portal 314 receiving (block 508) the data that is indicative of a result of the action that was initiated, e.g., the result of the requested benchmark test.

The depicted embodiment of method 500 supports a user selectable option for receiving test results. In the depicted embodiment, method 500 determines (block 510) whether the user of RFD 102 has elected to be electronically paged (block 512) when test results are received or whether the user of RFD 102 has elected to view the results via the I&R main menu. (block 514).

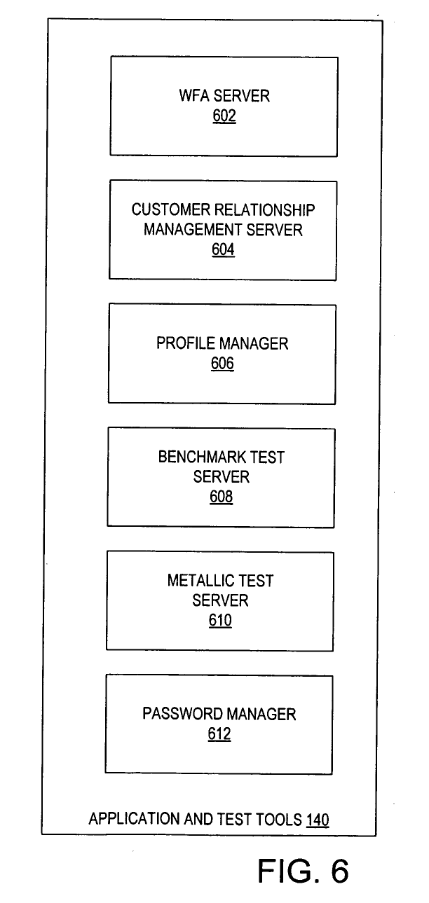

Referring now to FIG. 6, a block diagram illustrates selected elements of an embodiment of A&T tools 140. In the depicted embodiment, A&T tools 140 include a work force administration server 602 for marshalling an managing an installation and repair work force, a customer relationship management server 604 for providing support services to subscribers and other customers, a profile management 606 for managing preferences and other information pertaining to individual subscriber accounts, a benchmark test server 608 for initiating a benchmark testing sequence for a DSL or other subscriber connection, a metallic test server 610 for testing the physical medium of a client, and a password manager 612 for resetting, restoring, or otherwise maintaining a subscriber's individualized password.

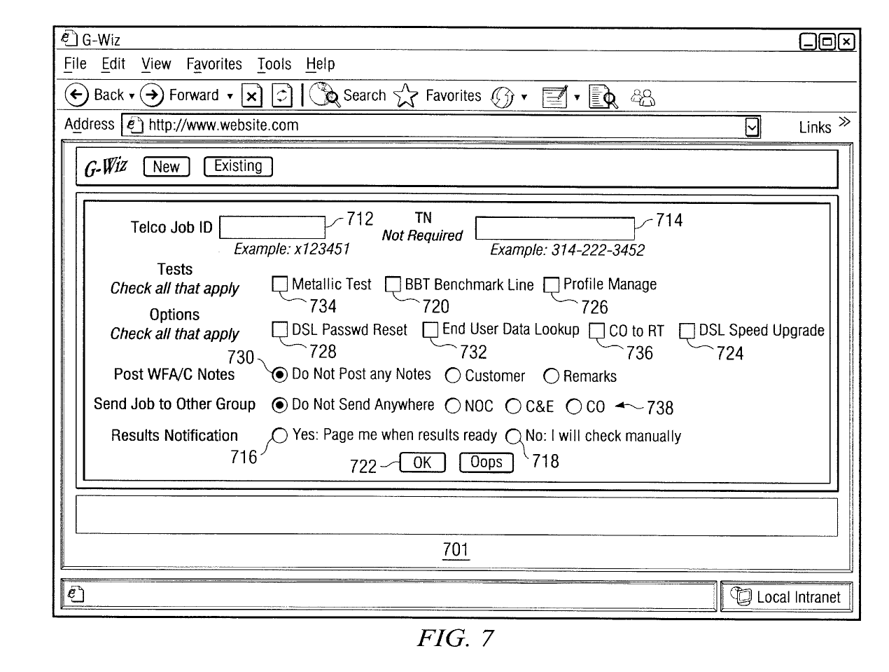

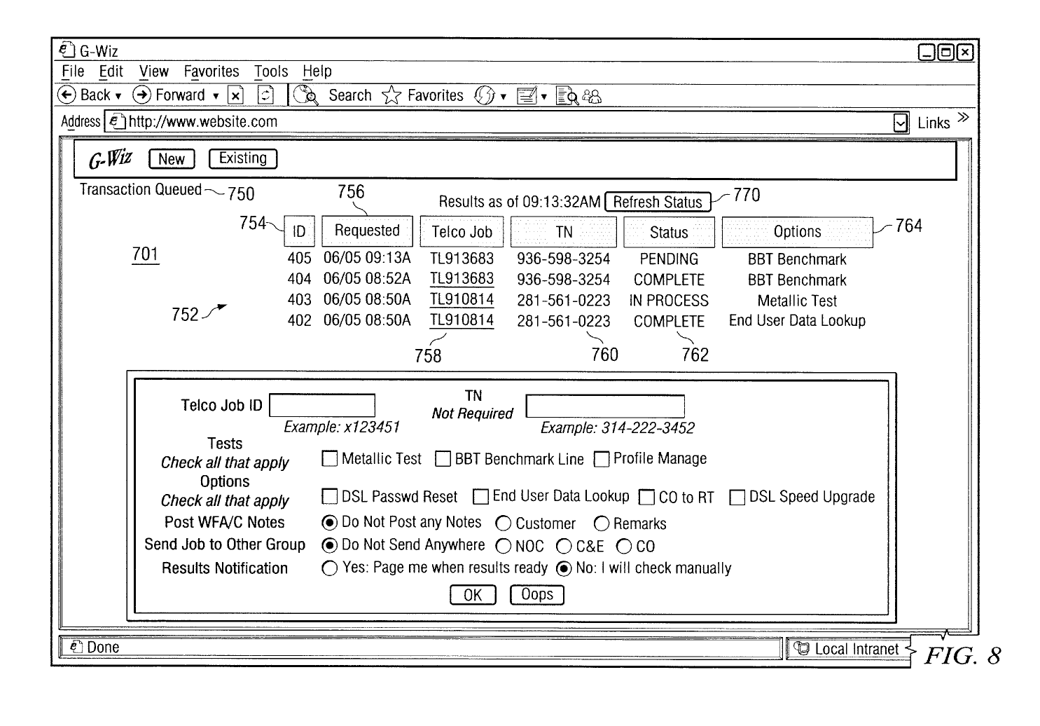

Referring now to FIG. 7 through FIG. 18, exemplary embodiments of various GUIs served by I&R portal web server 110 and/or I&R portal 314 are depicted to illustrate selected functionality of I&R portal web server 110. Although I&R portal web server 110 is described as being operable to generate a specific set of web pages and/or GUIs, portal web server 110 encompasses other implementations of the various GUIs and/or other test and applications that would occur to one skilled in the field of I&R services having the benefit of this disclosure.

Referring now to FIG. 7, an exemplary I&R portal main menu 701 is depicted. The depicted I&R main menu 701 is specifically applicable to I&R services for DSL. Other embodiments may include a different GUI including different tests.

In some embodiments, I&R portal main menu 701 is accessed when RFD 102 logs into the VPN 120 illustrated in FIG. 1 and invokes a web browser to open a web page that hosts the I&R portal. For example, a provider may have a web page that supports field technicians with various instructional web pages, informational web pages, and the like. I&R portal 314 may be included as a link in such a page, in which case the user of RFD 102 would click I&R portal link to invoke I&R portal 314. In this sequence, clicking the I&R portal link initiates an I&R portal session with I&R portal 314. Although a particular sequence for invoking or otherwise accessing the I&R portal has been described, other embodiments may employ other implementations for accessing the portal. For example, the portal may be embedded in a web page that is accessible outside of VPN 102.

I&R portal main menu 701 includes various selectable menu objects including fillable fields and various buttons corresponding to various applications and tests and to various user preferences. For example, the depicted embodiment of I&R main menu 701 includes a field 712 for entering a job number and a field 714 for entering a telephone number (TN) for the DSL connection being serviced. The I&R main menu 701 as shown also includes support for a user preference regarding delivery of test results. Specifically, I&R main menu 701 as shown includes mutually exclusive buttons 716 and 718 for indicating whether the user of RFD 102 is to be paged (button 716) when a test result is available or whether the user wishes to view the results manually (button 718).

I&R portal 314 and I&R portal main menu 701 provide the option for the user to manually review the results of the functions they have initiated. When the I&R portal user (the user of RFD 102) imitates a test or other action by clicking the “OK” button 722 with manual test results button 718 asserted, I&R portal 314 will queue the requested test or action to be processed and refresh I&R portal main menu 701. The refreshed I&R portal main menu 701, and example of which is depicted in FIG. 8, may include a text string 750 indicating that a transaction was queued. I&R portal 314 may also display on main menu 701 a list 752 of transactions that have been initiated by the user. The initiated transaction list 752 as shown includes a Transaction ID field 754, a Date/Time field 756 indicating when the transaction was requested, a Job ID field 758, a Telephone Number field 760, a Transaction Status field 762, and an options field 764 that indicates the name or type of transaction.

Above the list 752 of transactions, the depicted embodiment of I&R portal main menu 701 includes a “Refresh Status” button 770. Clicking button 770 causes I&R portal 314 to retrieve and display the current status of the listed transactions. In the depicted embodiment, transactions have one of four status types, namely, “Pending,” “In Process,” “Complete,” or “Failed.” In some embodiments, the I&R portal user can retrieve results for listed transactions having a “Complete” or “Failed” by clicking on the Job ID field 758 of the applicable transaction.

Anecdotal evidence suggests that one of the most frequently requested transactions in a DSL I&R environment is the DSL benchmark test. A DSL benchmark test measures parameters including upstream and downstream capacity, noise margin, signal attenuation, and speed. In conventional provider networks, a benchmark test for a DSL connection is hosted on a mainframe or other legacy system of the provider. When a field technician needs to benchmark a customer's line, the field technician makes a telephone call to a call center or service support center and makes a verbal request to initiate the benchmark test.

The I&R portal 314 alleviates the inconvenience and wasted time associated with making service center calls each time a particular test is desired. As shown in the embodiment depicted in FIG. 7, I&R portal main menu 701 includes a benchmark button 720 that is used to benchmark a DSL line. When a field technician or other user of RFD 102 wants to benchmark a line, the user would enter a Job ID in field 702 and enter the DSL telephone number in field 704. The user would then click benchmark button 720, set the desired results notification preference via buttons 716 and 718, and click “OK” button 722 to initiate the benchmark.

Whenever the RFD user clicks the OK button 722, I&R portal 314 identifies the transaction that has been specified and, when applicable, generates and transmits a request to initiate the transaction to application and test tools 140.

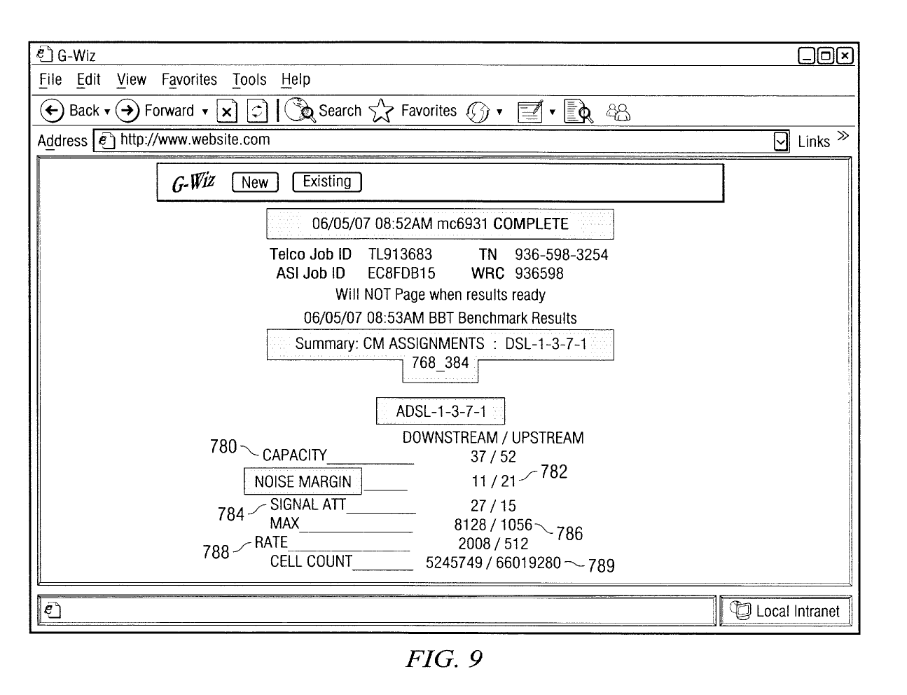

In some, embodiments, I&R portal 314 posts Benchmark Line readings directly to a log file each time a benchmark transaction is initiated. In addition, I&R portal 314 may display the results of a benchmark transaction, for example, when the user clicks on a completed benchmark transaction from the transaction list 752 of FIG. 8. FIG. 9 illustrates an exemplary embodiment of a GUI 702 that I&R portal 314 may invoke to display benchmark results. Benchmark results GUI 702 as depicted includes, in addition to indications of the job identification number and the telephone number, the date and time of the results as well as the various benchmark parameters. In the depicted embodiment, for example, GUI 702 includes upstream and downstream measures of capacity (780), noise margin (782), signal attenuation (784), a maximum data rate (786), a measured data rate (788), and a cell count (789). Other embodiments may display different parameters and/or may display the parameters in a different format.

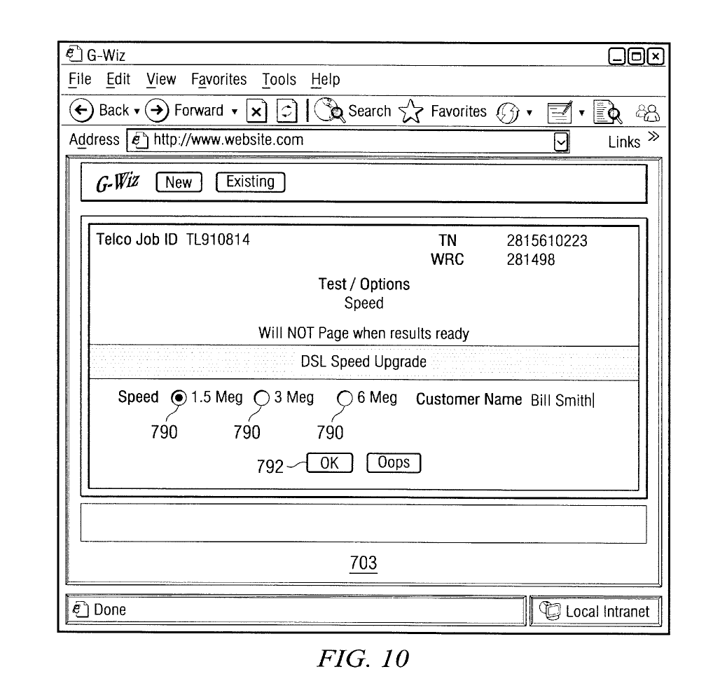

I&R portal 314 supports on-demand speed upgrades and profile management. The embodiment of main menu 701 depicted in FIG. 7 includes a DSL speed upgrade button 724 and a profile manage button 726. When a RFD user initiates a speed upgrade by selecting speed upgrade button 724 and clicking OK button 722, some embodiments of I&R portal 314 present the user with a speed upgrade GUI 703, an example of which is depicted in FIG. 10. The depicted embodiment of speed upgrade GUI 703, includes one or more speed buttons 790 that enable a user to specify a desired speed for the customer's DSL connection. The RFD user, after selecting a desired speed, clicks on OK button 792 to initiate a transaction that will adjust the speed of the connection according to the selected speed.

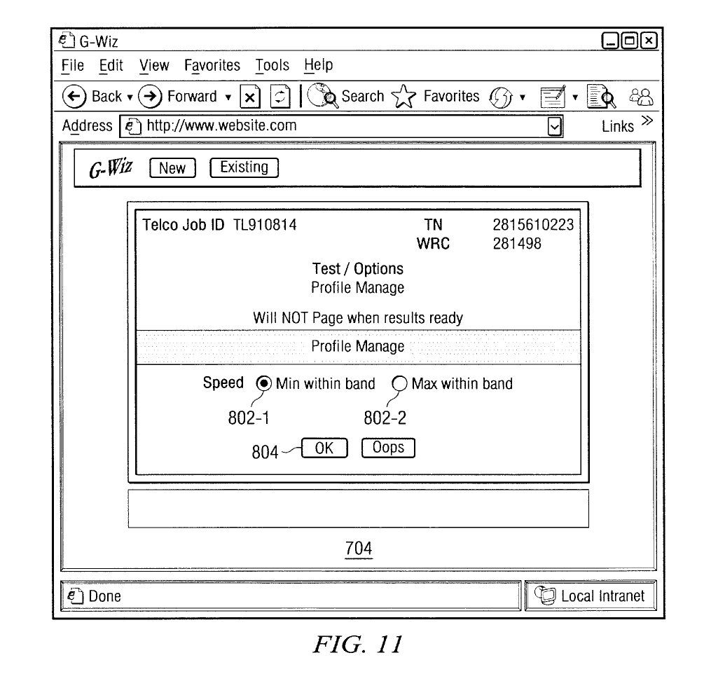

I&R portal 314 also supports profile management in via profile management button 726 in I&R main menu 701. The illustrated embodiment of I&R portal main menu 701 presents a profile management GUI in response to an RFD user selecting the profile management button and clicking the main menu OK button 722. FIG. 11 illustrates and exemplary profile management GUI 704. The depicted embodiment of GUI 704, includes buttons 802 to indicate where within a customer's bandwidth range the customer's DSL connection will operate. The depicted GUI 704, for example, includes MIN and MAX buttons 802 where the MIN button 802-1 specifies that the customer's DSL will operate a low end of an available speed range while MAX button 802-2 indicates that the customer's DSL line will operate at the high end of the available speed range. The RFD user would select one of the buttons 802 and click the profile manage OK button 804 to initiate the desired profile management. When the RFD user clicks profile manage OK button 804, RFD 102 transmits a request to I&R portal 314 via I&R portal web server 110. I&R portal 314 responds to the request by transmitting a request to invoke a profile management application in application and test tools 140.

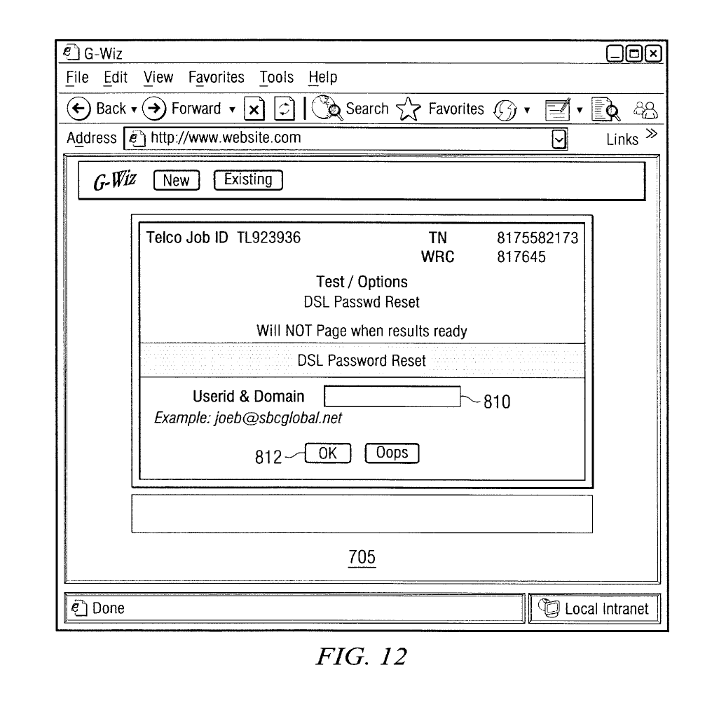

Another transaction that frequently requires field technicians on conventional networks to call a call center or service support center is the password management transaction. I&R portal 314 addresses the number of password reset calls field technicians would be required to make by enabling the field technician to initiate a password request using RFD 102. As depicted in FIG. 7, for example, I&R main menu 701 includes a password reset box 728 for this purpose. When a field technician of other user of RFD 102 clicks the password reset box 728 and clicks OK button 722, some embodiments of I&R portal 314 present a password reset GUI 705, an example of which is illustrated in FIG. 12. As depicted in FIG. 12 GUI 705 includes a field 810 for entering a user ID and domain associated with the customer's DSL account and a password reset OK button 812 that, when clicked, causes I&R portal 314 to transmit a password reset request to an appropriate resource in application and test tools 140.

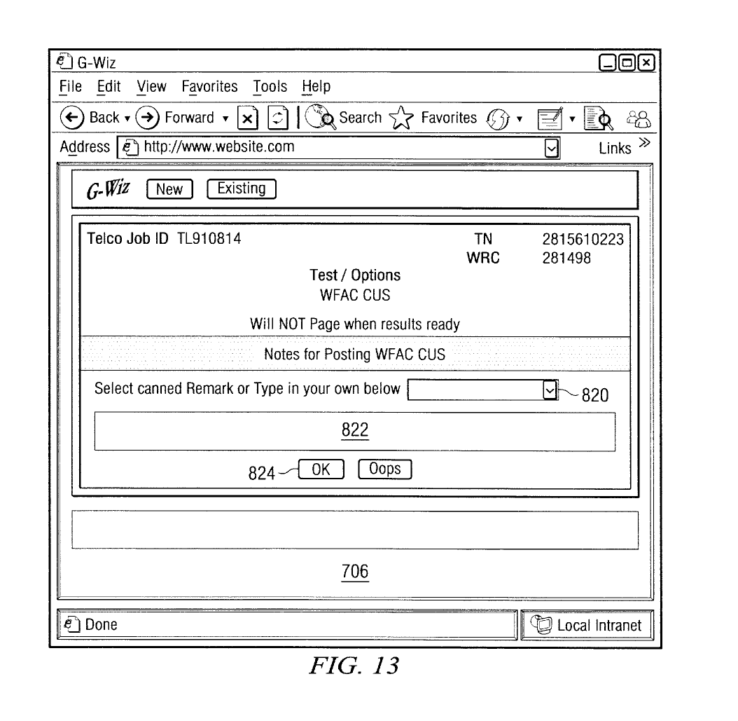

Some embodiments of I&R portal 314 support functionality enabling RFD users to post notes to a work force administration/control (WFA/C) system. I&R main menu 701, for example, includes a disable WFA/C button 730 that, when clicked, suspends the posting of WFA/C notes. When an RFD user clicks button 730 and then clicks OK button 722, some embodiments of I&R portal 314 present the user with a WFA/C GUI 706, an example of which is depicted in FIG. 13. The depicted embodiment of WFA/C GUI 706 includes a drop down box 820 that an RFD user may select a “canned” message to post to the WFA/C system and an text field 822 that the RFD user may use to enter customized notes to the WFA/C system. After selecting a canned note or typing in a customized note, the RFD user can click on OK button 824 to post the note.

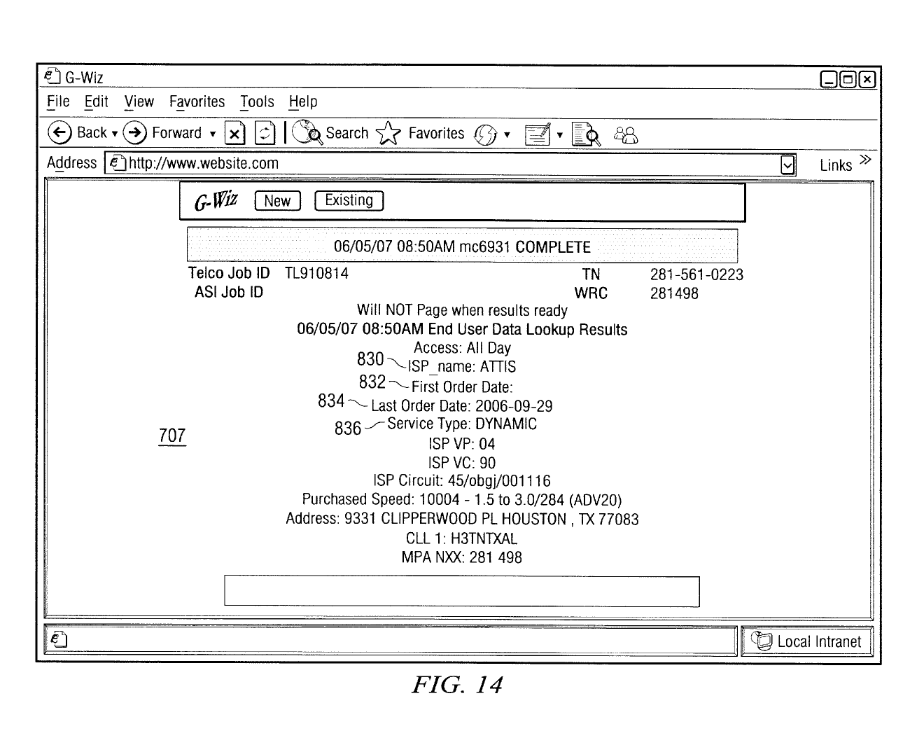

The depicted embodiment of I&R portal 314 supports field-initiated end user data lookup (EUDL) requests. I&R main menu 701 includes an EUDL button 732 that enable the RFD user to initiate an EUDL request. When an EUDL request is initiated, by clicking EUDL button 732 and then clicking I&R main menu OK button 722, the illustrated embodiment of I&R portal 314 presents an EUDL GUI 707 to the RFD user. An exemplary EUDL GUI 707 is depicted in FIG. 14. EUDL GUI 707 as depicted, provides the RFD user with account information associated with the customer. The account information may include, as examples, an ISP name 830, a first order date 832, a last order date 834, a service type 836, and so forth. While the illustrated embodiment of EUDL GUI 707 includes certain types of account information other embodiments may include additional, less, and/or different information that the information presented in EUDL GUI 707.

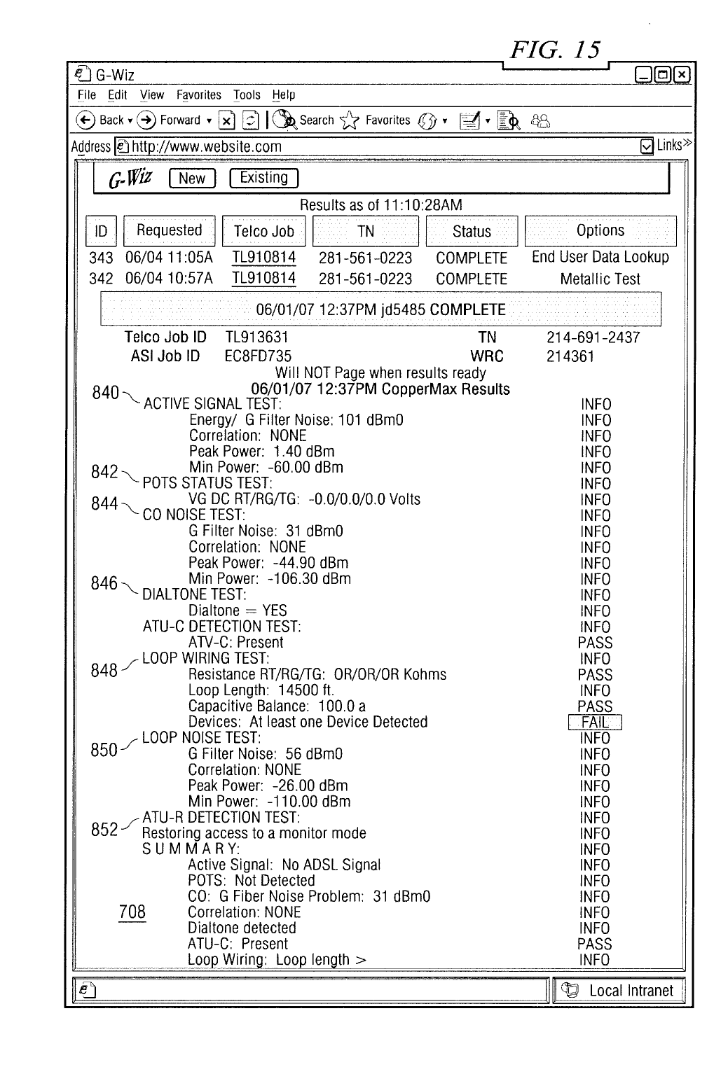

I&R portal 314 may further support various types of metallic testing functions. Metallic testing generally refers to tests on the physical layer, local loop, or last mile of a DSL connection. I&R main menu 701 as depicted in FIG. 7 includes a metallic test button 734 that, when checked, enables the RFD user to initiate one or more types of metallic tests depending upon the metallic tests supported by the network. When the RFD user checks metallic test button 734 and clicks OK button 722 from I&R main menu 701, some embodiments of I&R portal 314 present the RFD user with a metallic GUI 708, an illustrative example of which is shown in FIG. 15. The embodiment of metallic GUI 708 depicted in FIG. 15 displays results for various metallic tests including, as examples, active signal tests 840, plain old telephone service (POTS) tests 842, central office noise tests 844, dial tone tests 846, loop wiring tests 848, loop noise tests 850, as well as a summary 852 of the tests. The metallic GUI 708 of FIG. 15 is a relatively detailed metallic test that may be performed by third party metallic testing hardware including hardware from, for example, CopperMax.

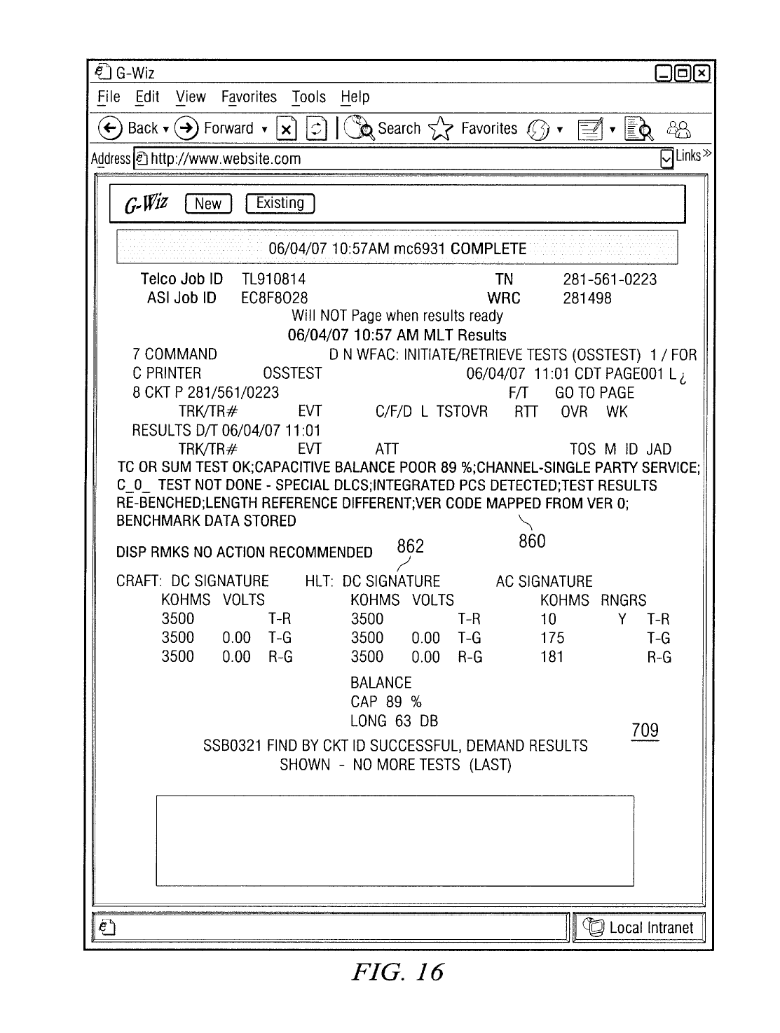

FIG. 16 illustrates a second example of a metallic GUI 709. GUI 709 is exemplary of a more generic type of metallic test. The metallic test may display various metallic test results including, as examples, a textual summary of the metallic test and a DC signature 862.

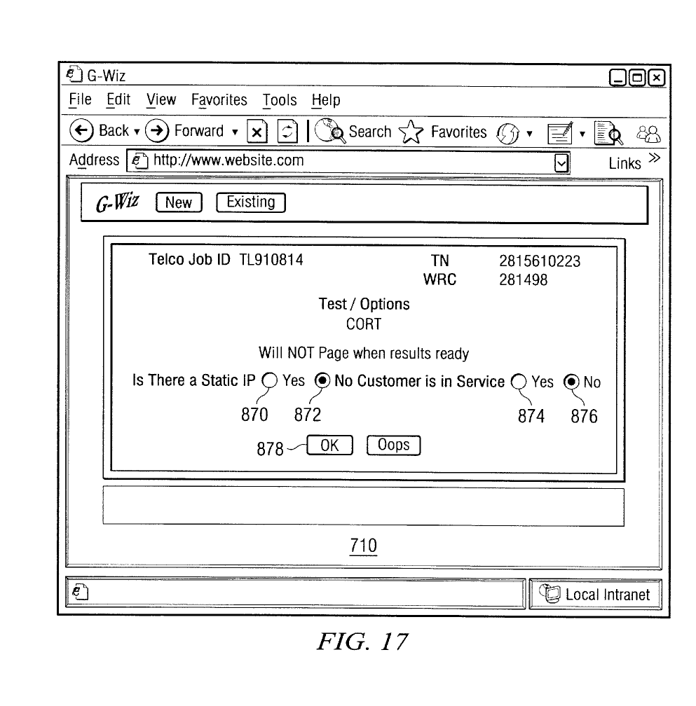

FIG. 17 illustrates an embodiment of a central office to remote terminal (CO/RT) conversion GUI 710. CO/RT GUI 710 is invoked by the RFD user to initiate a request to convert a customer from a CO-based service to an RT-based service. The depicted embodiment of CO/RT GUI includes buttons 870 and 872 to indicate whether the DSL service employs static IP addresses and buttons 874 and 876 to indicate whether the customer is currently in service. When the RFD user specifies this information and clicks the OK button 878, I&R portal 314 may generate a request to initiate the transfer.

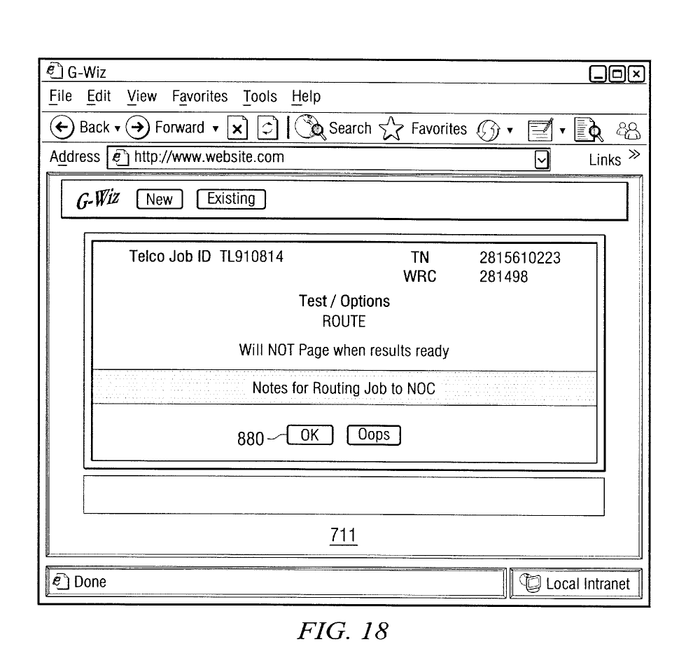

I&R portal 314 further supports functionality enabling the RFD user to transfer a job from one group to another group within the provider's enterprise. I&R main menu 701, for example, includes a set of buttons 738 enabling the RFD user to specify which of various groups to a send a job to. The set of buttons 738 illustrated in FIG. 7, for example, include a network operating center (NOC), a construction and engineering (C&E) center, and a central office. By clicking one of these buttons 738 and clicking OK button 722, I&R portal 314 presents GUI 711 as depicted in FIG. 18. The RFD user may then click the OK button 880 to confirm the request to send a job to another group.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A web server includes a processor and tangible, computer readable storage medium accessible to the processor, wherein, embedded in the storage, are executable instructions to support installation and repair services in conjunction with a telecommunication service provided to a customer by a provider, the instructions comprising instructions to:
in response to a first input from a remote field device, provide a first I&R user interface, including a plurality of selectable I&R objects;
receive a second input from the remote field device indicating a user's selection of one of the I&R objects;
generate a request to invoke an I&R application in response to receiving the input;
transmit the request to invoke the I&R application to an I&R system;
receive I&R data generated by the I&R application from the I&R system; and
convey information indicative of the I&R data to the remote field device.

2. The system of claim 1, wherein the receiving of the input comprising receiving the input from the RFD via a wireless network adapter of the web server operable to establish a wide area cellular connection with the RFD.

3. The system of claim 1, wherein the telecommunication service includes a broadband connection service to provide a broadband connection for the customer and wherein the broadband connection service is associated with a broadband account of the customer and further wherein the I&R application is operable to configure the broadband connection.

4. The system of claim 3, wherein the I&R application is operable to perform a metallic test on the broadband connection.

5. The system of claim 3, wherein the I&R app is operable to perform a benchmark test on the broadband connection.

6. The system of claim 1, wherein the telecommunication service includes a broadband connection service to provide a broadband connection for the customer and wherein the broadband connection service is associated with a broadband account of the customer and further wherein the I&R application is operable to manage the broadband account.

7. The system of claim 6, wherein the telecommunication service includes a service to provide a broadband connection and further wherein the I&R application is operable to configure the broadband connection.

8. The system of claim 7, wherein the I&R application is operable to configure an account setting, wherein the account setting is selected from the group consisting of a password.

9. The system of claim 6, wherein the I&R application is operable to configure a customer's broadband connection.

10. A method for supporting installation and repair (I&R) services for a telecommunication network, the method comprising:
enabling a web server to respond to receiving an initial request from a browser of a remote field device by presenting an I&R portal main menu to the remote field device browser wherein the I&R portal main menu includes at least one selectable menu object suitable for initiating a test or application pertaining to the telecommunication network;
enabling the web server to respond to receiving from the browser an indication of a selection of the test or application by transmitting to an application and test (A&T) resource a request to initiate the application or test; and
enabling the web server to respond to receiving from the A&T resource information indicative of a completion or result of the application or test by presenting information indicative of the completion or result to the browser.

11. The method of claim 10, wherein the test or application is selected from a metallic test, a DSL benchmark test, and a profile management application.

12. The method of claim 10, wherein the profile management resource is operable to initiate at least one of a password reset and a DSL speed upgrade.

13. The method of claim 10, wherein the selected application is operable to post a note or message to a work force administration resource.

14. The method of claim 10, wherein the selected application is operable to send a job associated with the selected test or application to a different functional group within the telecommunication network.

15. The method of claim 10, wherein the I&R portal main menu includes selected objects for indicating how the web portal server presents results.

16. The method of claim 15, wherein the portal server includes a first selectable object to receive results via a paging service and a second object for receiving results from a web page associated with the web portal server.

17. A method of supporting telecommunications installation and repair services, comprising:
presenting an I&R main menu to a browser of a remote field device in response to the browser requesting an I&R portal;
detecting the browser transmitting an indication of information indicative of a menu selection;
determining a test or application corresponding to the menu selection;
generating a test or application request applicable to the determined test or application;
sending the generated request to a legacy application or test resource;
detecting a response from the legacy application or test resource, wherein the response is indicative of a result or completion of the request application or resource; and
sending information indicative of the detected response to the browser.

18. The method of claim 17, wherein said menu selection corresponds to a test or application applicable to a digital subscriber line service of a subscriber.

19. The method of claim 17, wherein said detecting of said browser transmitting comprises detecting the browser wirelessly transmitting the indication to a base station of a cellular network.

20. The method of claim 19, wherein the indication is subsequently transmitted from the cellular base station to a server over a wireline medium.

21. The method of claim 20, wherein the indication is subsequently transmitted over a virtual private network.

22. The method of claim 17, wherein said I&R main menu includes objects for selecting any of a plurality of tests, wherein the plurality of test includes a test for benchmark testing the DSL service and a test for performing a metallic test of a local loop associated with the service.

23. The method of claim 17, wherein the I&R main menu further includes an object for managing a subscriber's password and a service for managing a subscriber's profile.

24. The method of claim 23, wherein the object for managing the subscriber's profile includes an object for indicating a permitted speed or data transfer rate associated with the service.
